(19) United States
(12) Patent Application Publication
(10) Pub. No.: US 2020/0142424 A1
(43) Pub. Date: May 7, 2020

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Tsugumi OTSUKA, Nagoya-shi (JP); Kazuya NISHIMURA, Okazaki-shi (JP); Yuki ITO, Iwakura-shi (JP); Akio UOTANI, Nagoya-shi (JP); Makoto AKAHANE, Nagoya-shi (JP); Wataru SHIINA, Nagoya-shi (JP)

(73) Assignee: TOYOTA JIDOSHA KABUSHIKI KAISHA, Toyota-shi (JP)

(21) Appl. No.: 16/666,474

(22) Filed: Oct. 29, 2019

(30) Foreign Application Priority Data
Nov. 6, 2018 (JP) 2018-208675

(51) Int. Cl. G05D 1/02; G08G 1/00; G08G 1/01; G06Q 30/02

(52) U.S. Cl. CPC G05D 1/0223; G08G 1/207; G05D 1/0088; G06Q 30/0266; G08G 1/0125

(57) ABSTRACT

An object is to provide a technique for enhancing an appealing effect of an advertisement by specifying, in a simple manner, a location where a vehicle is desired to travel at a low speed or to stop, and by guiding, to the location, a vehicle that outputs an advertisement to outside. An information processing apparatus includes a controller configured to: acquire information about traffic; specify, on a basis of the information about traffic that is acquired, a location where a vehicle that outputs an advertisement to outside is desired to travel at a speed at or below a predetermined speed or to stop; determine a route from a location of the vehicle to the location that is specified; and guide the vehicle to the location that is specified, on a basis of the route that is determined.

### CROSS REFERENCE TO RELATED APPLICATION

This application claims the benefit of Japanese Patent Application No. 2018-208675, filed on Nov. 6, 2018, which is hereby incorporated by reference herein in its entirety.

### BACKGROUND

### Technical Field

The present disclosure relates to an information processing apparatus, an information processing method, and a non-transitory storage medium.

### Description of the Related Art

There is disclosed a technique of effectively providing advertising contents by detecting a congested area and guiding a mobile body for business use to the area (for example, Patent document 1).

### CITATION LIST

### [Patent Document]

[Patent document 1] Japanese Patent Laid-Open No. 2017-138243

### SUMMARY

An object of the present disclosure is to provide a technique for enhancing an appealing effect of an advertisement by specifying, in a simple manner, a location where a vehicle is desired to travel at a low speed or to stop, and by guiding, to the location, a vehicle that outputs an advertisement to outside.

A first aspect of the present disclosure is an information processing apparatus including a controller configured to:

acquire information about traffic;

specify, on a basis of the information about traffic that is acquired, a location where a vehicle that outputs an advertisement to outside is desired to travel at a speed at or below a predetermined speed or to stop;

determine a route from a location of the vehicle to the location that is specified; and

guide the vehicle to the location that is specified, on a basis of the route that is determined.

A second aspect of the present disclosure is an information processing method including:

acquiring information about traffic;

specifying, on a basis of the information about traffic that is acquired, a location where a vehicle that outputs an advertisement to outside is desired to travel at a speed at or below a predetermined speed or to stop;

determining a route from a location of the vehicle to the location that is specified; and

guiding the vehicle to the location that is specified, on a basis of the route that is determined.

A third aspect of the present disclosure is a program or a non-transitory computer-readable storage medium storing the program for causing a computer to:

acquire information about traffic;

specify, on a basis of the information about traffic that is acquired, a location where a vehicle that outputs an advertisement to outside is desired to travel at a speed at or below a predetermined speed or to stop;

determine a route from a location of the vehicle to the location that is specified; and

guide the vehicle to the location that is specified, on a basis of the route that is determined.

According to the present disclosure, a technique may be provided according to which an appealing effect of an advertisement is enhanced by specifying, in a simple manner, a location where a vehicle is desired to travel at a low speed or to stop, and by guiding, to the location, a vehicle that outputs an advertisement to outside.

### BRIEF DESCRIPTION OF THE DRAWINGS

FIG. 1 illustrates an example overview of a configuration of a vehicle guidance system according to a first embodiment;

FIG. 2 illustrates an example overview of a functional configuration of an information terminal;

FIG. 3 illustrates an example overview of a functional configuration of a traffic signal information acquisition server;

FIG. 4 illustrates an example flowchart of a process performed by the information terminal to guide a vehicle to a location where a traffic signal is to turn red, on the basis of traffic signal information;

FIG. 5 illustrates an example overview of a configuration of an information terminal according to a second embodiment;

FIG. 6 illustrates an example overview of a functional configuration of the information terminal; and

FIG. 7 illustrates an example flowchart of a process performed by the information terminal to guide a vehicle to a location where there is occurrence of traffic congestion, on the basis of traffic congestion information.

### DESCRIPTION OF THE EMBODIMENTS

With an information processing apparatus according to a first mode of the present disclosure, a controller acquires information about traffic. The information here about traffic includes information about a traffic signal, information about traffic congestion, information about traffic regulation, information about a parking lot, and information about a crossing gate provided at a railroad crossing.

Furthermore, the controller specifies, on the basis of the information about traffic that is acquired, a location where a vehicle that outputs an advertisement to outside is desired to travel at a speed at or below a predetermined speed or to stop. The vehicle here that outputs an advertisement to outside includes a vehicle including, on a vehicle body, a medium for outputting an advertisement, or a vehicle having an advertisement directly applied on a vehicle body. The medium for outputting an advertisement includes a display and a speaker. Furthermore, the vehicle includes a dedicated vehicle for display of an advertisement, an autonomous vehicle, and an unmanned transport vehicle.

Furthermore, for example, the predetermined speed is a speed that is 50 percent of a speed limit on a road where the vehicle that outputs an advertisement to outside is to travel. Moreover, the location where the vehicle is desired to travel at a speed at or below the predetermined speed or to stop includes a location where a traffic signal is to turn red, a location where there is occurrence of traffic congestion, a location where traffic regulation is enforced, a road near a parking lot which is full, and a location where a crossing gate at a railroad crossing is to be closed. Moreover, in the following embodiments, traveling at a speed at or below the predetermined speed will be referred to as traveling at a low speed.

Furthermore, the controller determines a route from a location of the vehicle to the location that is specified.

Then, the controller guides the vehicle to the location that is specified, on the basis of the route that is determined.

With the information processing apparatus as described above, the vehicle that outputs an advertisement to outside is guided to a location where the vehicle is desired to travel at a low speed or to stop. Accordingly, people in the periphery of the location are able to view the advertisement that is output by the vehicle for a long time. That is, the information processing apparatus as described above enables an appealing effect of an advertisement to be enhanced.

Moreover, with the information processing apparatus as described above, a location where the vehicle is desired to travel at a low speed or to stop may be specified in a simple manner without acquiring location information from a mobile terminal carried by a person who is in the periphery of the location where the vehicle is desired to travel at a low speed or to stop or from a mobile terminal carried by a user of the vehicle. Accordingly, a process for specifying the location may be prevented from becoming complicated, and also, a load of the process may be reduced.

### First Embodiment

(System Configuration)

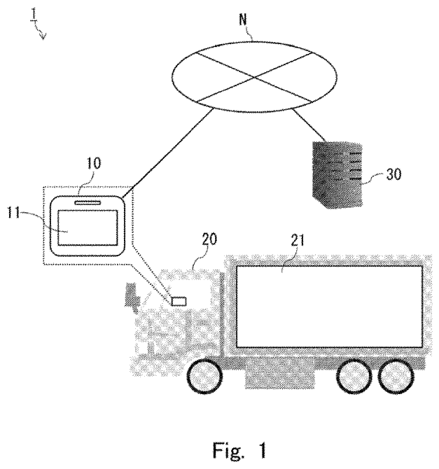

FIG. 1 illustrates an example overview of a configuration of a vehicle guidance system 1 according to a first embodiment. The vehicle guidance system 1 according to the present embodiment includes an information terminal 10, a vehicle 20, and a traffic signal information acquisition server 30. The information terminal 10 here is an example of an “information processing apparatus” of the present disclosure.

For example, the information terminal 10 is a navigation device. However, the information terminal 10 may also be a smartphone, a tablet terminal, or a laptop computer. The information terminal 10 includes a display 11.

The information terminal 10 is mounted in the vehicle 20. The vehicle 20 includes a display 21 for advertisement where an advertisement is to be displayed. The display 21 for advertisement is installed on a vehicle body of the vehicle 20.

The traffic signal information acquisition server 30 acquires information about a traffic signal from a traffic control center, for example.

With the vehicle guidance system 1 according to the present embodiment, the information terminal 10 and the traffic signal information acquisition server 30 are connected to each other by a network (N). As the network, a wide area network (WAN), which is a worldwide public communication network such as the Internet, or other communication networks may be adopted, for example. Furthermore, the network may include a mobile communication network for mobile phones, and a wireless communication network such as Wi-Fi®.

(Functional Configuration)

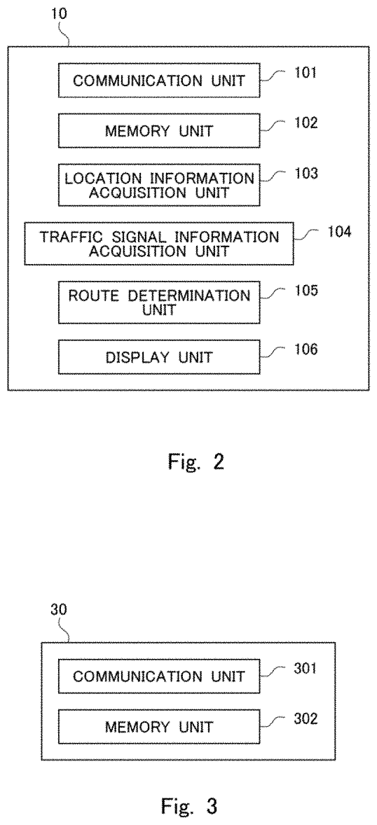

FIG. 2 illustrates an example overview of a functional configuration of the information terminal 10. The information terminal 10 is a computer including a processor such as a CPU, main memories such as a RAM, a ROM and the like, an auxiliary memory such as an EPROM, a hard disk drive or a removable medium, an input device, and a display device. Additionally, the removable medium may be a USB memory, or a disk recording medium such as a CD or a DVD, for example. An operating system (OS), various programs, various tables and the like are stored in the auxiliary memory, and functions matching predetermined objects as described later may be implemented by loading, and executing, the stored programs in a work area of the main memory, and by controlling each structural component and the like through execution of the programs. The information terminal 10 further includes a global positioning system (GPS) module.

The information terminal 10 includes a communication unit 101. The communication unit 101 is a wireless communication interface for connecting the information terminal 10 to the network. For example, the communication unit 101 provides access to the network through a local area network (LAN) or a mobile communication service such as 3rd Generation (3G) or Long Term Evolution (LTE).

Moreover, the information terminal 10 includes a memory unit 102. The memory unit 102 includes a main memory and an auxiliary memory. The main memory is a memory where programs to be executed by the processor and data to be used by the control programs are developed. The auxiliary memory is a device where programs to be executed by the processor and data to be used by the control programs are stored. The auxiliary memory may store an operating system for executing the programs. Functions described above are implemented by the programs stored in the auxiliary memory being loaded in the main memory and executed by the processor.

Furthermore, the information terminal 10 includes a location information acquisition unit 103. The location information acquisition unit 103 includes a function of acquiring location information of the information terminal 10. For example, the location information acquisition unit 103 includes a GPS module, and acquires location information (such as latitude and longitude) of the information terminal 10.

Furthermore, the information terminal 10 includes a traffic signal information acquisition unit 104. The traffic signal information acquisition unit 104 acquires, through the communication unit 101, information about a traffic signal from the traffic signal information acquisition server 30. For example, the information about a traffic signal is information about a location where a traffic light is installed, information about a time of switching of a traffic signal, and the like.

Moreover, the information terminal 10 includes a route determination unit 105. The route determination unit 105 sets a departure point and a destination. A route from the departure point to the destination is searched on the basis of information about the departure point and information about the destination. An existing search algorithm is used to search for the route. Furthermore, the route determination unit 105 includes a function of determining a retrieved route as a route along which to guide the vehicle 20, on the basis of a time of arrival of the vehicle 20 and the information about a traffic signal in a case where the vehicle 20 is assumed to arrive at the destination by the retrieved route.

Furthermore, the information terminal 10 includes a display unit 106. The display unit 106 includes a function of causing information to be displayed on the display 11.

Moreover, FIG. 3 illustrates an example overview of a functional configuration of the traffic signal information acquisition server 30. The traffic signal information acquisition server 30 illustrated in FIG. 3 is a computer including a processor such as a CPU, main memories such as a RAM, a ROM and the like, and an auxiliary memory such as an EPROM, a hard disk drive or a removable medium. The removable medium may be a USB memory, or a disk recording medium such as a CD or a DVD, for example. An operating system (OS), various programs, various tables and the like are stored in the auxiliary memory, and functions matching predetermined objects as described later may be implemented by loading, and executing, the stored programs in a work area of the main memory, and by controlling each structural component and the like through execution of the programs.

The traffic signal information acquisition server 30 includes a communication unit 301. The communication unit 301 is a wireless communication interface for connecting the traffic signal information acquisition server 30 to the network. For example, the communication unit 301 provides access to the network through a local area network (LAN) or a mobile communication service such as 3rd Generation (3G) or Long Term Evolution (LTE).

Moreover, the traffic signal information acquisition server 30 includes a memory unit 302. The memory unit 302 includes a main memory and an auxiliary memory. The main memory is a memory where programs to be executed by the processor and data to be used by the control programs are developed. The auxiliary memory is a device where programs to be executed by the processor and data to be used by the control programs are stored. The auxiliary memory may store an operating system for executing the programs. Functions described above are implemented by the programs stored in the auxiliary memory being loaded in the main memory and executed by the processor. The memory unit 302 stores information about a traffic signal acquired from a traffic control center in the main memory or the auxiliary memory, for example.

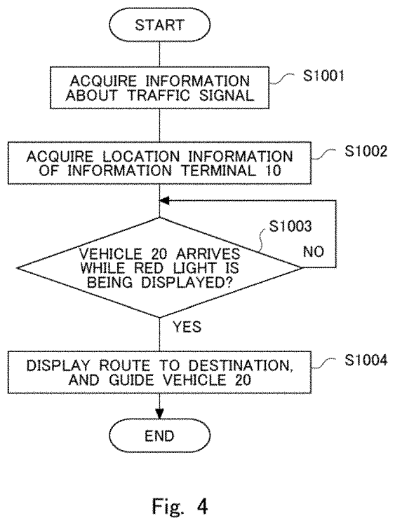

(Processing Flow of Information Terminal 10) Next, a processing flow to be performed by the information terminal 10 will be described. FIG. 4 illustrates an example flowchart of a process performed by the information terminal 10 to acquire traffic signal information from the traffic signal information acquisition server 30, and to guide the vehicle 20 to a location where a traffic signal is to turn red.

(S1001)

In step S1001, the traffic signal information acquisition unit 104 acquires from the traffic signal information acquisition server 30, through the communication unit 101, information about a location where a traffic light is installed, and information about a time of switching of a traffic signal. Furthermore, the memory unit 102 stores the acquired information about a location where a traffic light is installed, and the acquired information about a time of switching of a traffic signal.

(S1002)

In step S1002, the location information acquisition unit 103 acquires location information of the information terminal 10. That is, the information terminal 10 is mounted in the vehicle 20, and thus, the location information acquisition unit 103 acquires location information of the vehicle 20.

(S1003)

In step S1003, the route determination unit 105 extracts, from the acquired information about a location where a traffic light is installed, information about a location of a certain traffic light which is installed in a region or a range where display of an advertisement is desired by an advertiser. Then, the route determination unit extracts information about a time of switching of a signal from green to red, with respect to the traffic light.

Then, the route determination unit 105 sets the location of the traffic light as the destination. Furthermore, the route determination unit 105 sets the location of the vehicle 20 acquired in step S1002 as the departure point. Then, the route determination unit 105 searches for a route from the departure point to the destination. Here, at the time of searching for the route, if there is a via-point desired by the advertiser, a route that passes through the via-point is created. Then, the route determination unit 105 determines whether, in a case where the vehicle 20 is guided along the created route, the vehicle 20 arrives at the destination at a time when the signal of the traffic light at the destination is switched from green to red to display red.

(S1004)

In step S1004, in the case of determining that, in a case where the vehicle 20 is guided along the created route, the vehicle 20 arrives at the destination at a time when the signal of the traffic light at the destination is switched from green to red to display red, the route determination unit 105 determines the created route as the route along which the vehicle 20 is guided to the destination. Then, the display unit 106 displays the determined route on the display 11.

A driver of the vehicle 20 drives by looking at the route displayed on the display 11. The vehicle 20 is thus guided to the destination. The signal of the traffic light installed at the destination is red when the vehicle 20 arrives at the destination. That is, the vehicle 20 is to stop at the destination for a predetermined time. An advertisement is kept displayed on the display 21 for advertisement of the vehicle 20 while the vehicle 20 is stopped. Moreover, the advertisement is displayed on the display 21 for advertisement not only when the vehicle 20 is stopped but also when the vehicle 20 is traveling.

Moreover, in the case of determining that, in a case where the vehicle 20 is guided along the created route, the vehicle 20 does not arrive at the destination at a time when the signal of the traffic light at the destination is switched from green to red to display red, the route determination unit 105 extracts information about another traffic light which is installed in the region or the range where display of the advertisement is desired by the advertiser, from the acquired information about a location where a traffic light is installed, and repeats the processes from step S1003.

(Effects of First Embodiment)

With the vehicle guidance system 1 according to the first embodiment, people in the periphery of a traffic light to which the vehicle 20 is guided and where red is displayed are able to view the advertisement displayed by the vehicle 20 for a long time. That is, with the vehicle guidance system 1 according to the first embodiment, an appealing effect of the advertisement may be enhanced.

Moreover, with the vehicle guidance system 1 according to the first embodiment, a location where a traffic light where the signal is to turn red and the vehicle 20 will be desired to stop is installed may be specified in a simple manner without acquiring location information from a mobile terminal carried by a person in the periphery of the traffic light or from a mobile terminal carried by a user of the vehicle 20. Accordingly, the process for specifying the location where the traffic light is installed may be prevented from becoming complicated, and the load for the process may be reduced.

### Second Embodiment

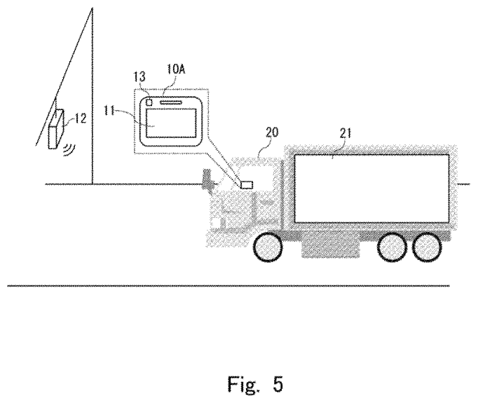

FIG. 5 illustrates an example overview of a configuration of an information terminal 10A according to a second embodiment. The information terminal 10A is an example of the “information processing apparatus” of the present disclosure. The information terminal 10 and the information terminal 10A are different from each other in that the information terminal 10A includes a beacon reception module 13 that receives a beacon signal that is transmitted from a beacon transmission terminal 12 installed on a road. For example, a beacon signal about information about traffic, issued by Vehicle Information and Communication System (VICS®), is transmitted from the beacon transmission terminal 12. The information terminal 10A receives the beacon signal about information about traffic through the beacon reception module 13.

(Functional Configuration)

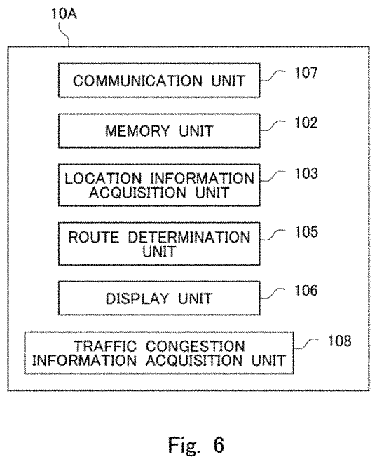

FIG. 6 illustrates an example overview of a functional configuration of the information terminal 10A. The information terminal 10A includes a communication unit 107. The communication unit 107 includes a function of receiving, through the beacon reception module 13, a beacon signal that is transmitted from outside. Moreover, the communication unit 107 may include, but does not have to include, a wireless communication interface for connecting the information terminal 10A to a network.

The information terminal 10A further includes a traffic congestion information acquisition unit 108. The traffic congestion information acquisition unit 108 acquires, through the communication unit 107, information about traffic that is issued by VICS. The information about traffic is information about a location where there is occurrence of traffic congestion, for example.

Furthermore, like the information terminal 10, the information terminal 10A includes the memory unit 102, the location information acquisition unit 103, the route determination unit 105, and the display unit 106.

(Processing Flow of Information Terminal 10A)

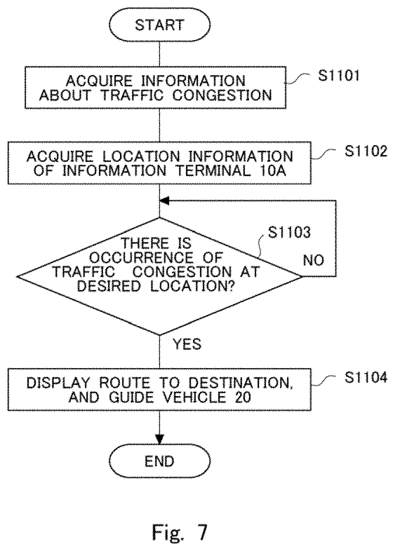

Next, a processing flow to be performed by the information terminal 10A will be described. FIG. 7 illustrates an example flowchart of a process performed by the information terminal 10A to acquire, from the beacon transmission terminal 12, information about a location where there is occurrence of traffic congestion, and to guide the vehicle 20 to the location where there is occurrence of traffic congestion.

(S1101)

In step S1101, the traffic congestion information acquisition unit 108 acquires from the beacon transmission terminal 12, through the communication unit 107, information about a location where there is occurrence of traffic congestion.

(S1102)

In step S1102, the location information acquisition unit 103 acquires location information of the information terminal 10A. That is, the information terminal 10A is mounted in the vehicle 20, and thus, the location information acquisition unit 103 acquires location information of the vehicle 20.

(S1103)

In step S1103, the route determination unit 105 extracts a location where there is occurrence of a certain traffic congestion, from the acquired information about a location where there is occurrence of traffic congestion. Then, whether or not the extracted location where there is occurrence of traffic congestion is a location in a region or a range where display of an advertisement is desired by an advertiser is determined.

(S1104)

In step S1104, in the case of determining that the extracted location where there is occurrence of traffic congestion is a location in the region or the range where display of an advertisement is desired by an advertiser, the route determination unit 105 sets the location where there is occurrence of traffic congestion as the destination. Furthermore, the route determination unit 105 sets the location of the vehicle 20 acquired in step S1102 as the departure point. Then, the route determination unit 105 searches for a route from the departure point to the destination. Here, at the time of searching for the route, if there is a via-point desired by the advertiser, a route that passes through the via-point is created. Then, the created route is determined as the route from the location of the vehicle 20 to the destination. Then, the display unit 106 displays the determined route on the display 11. The via-point here that is desired by the advertiser is an example of a “predetermined via-point” of the present disclosure.

A driver of the vehicle 20 drives by looking at the route displayed on the display 11. The vehicle 20 is thus guided to the destination. When the vehicle 20 reaches near the destination, the vehicle 20 gets caught in the traffic congestion to travel at a low speed or to stop at the destination. The advertisement is kept displayed on the display 21 for advertisement of the vehicle 20 while the vehicle 20 is traveling at a low speed or is stopped. Moreover, the advertisement is displayed on the display 21 for advertisement not only when the vehicle 20 is traveling at a low speed or is stopped but also when the vehicle 20 is traveling at a speed higher than 50% of a speed limit.

Moreover, in the case of not determining that the extracted location where there is occurrence of traffic congestion is a location in the region or the range where display of the advertisement is desired by the advertiser, the route determination unit 105 extracts another location where there is occurrence of traffic congestion from the acquired information about a location where there is occurrence of traffic congestion, and repeats the processes from step S1103.

(Effects of Second Embodiment)

With the information terminal 10A according to the second embodiment, people in the periphery of the location where there is occurrence of the traffic congestion and to which the vehicle 20 is guided are able to view the advertisement displayed by the vehicle 20 for a long time. That is, with the information terminal 10A according to the second embodiment, an appealing effect of the advertisement may be enhanced.

Moreover, with the information terminal 10A according to the second embodiment, a location where there is occurrence of traffic congestion may be specified in a simple manner without acquiring location information from a mobile terminal carried by a person in the periphery of the location where there is occurrence of the traffic congestion or from a mobile terminal carried by a user of the vehicle 20. Furthermore, with the information terminal 10A according to the second embodiment, a location where there is occurrence of traffic congestion may be specified in a simple manner through VICS or the beacon transmission terminal used by regular navigation devices and the like. Accordingly, the process for specifying the location where there is occurrence of the traffic congestion may be prevented from becoming complicated, and the load for the process may be reduced.

### Other Embodiments

In the process in step S1003, the route determination unit 105 extracts a traffic light that serves as a candidate destination from traffic lights installed in the region or the range where display of an advertisement is desired by an advertiser. Furthermore, in the process in step S1104, the route determination unit 105 sets a location where there is occurrence of traffic congestion as the destination, in the case where the location where there is occurrence of the traffic congestion is in the region or the range where display of an advertisement is desired by the advertiser. However, a location where display of the advertisement is desired by the advertiser does not have to be taken into account at the time of determining the destinations mentioned above. For example, the destination may be a traffic light at a location close to the location of the vehicle 20, or the destination may be a location which is close to the location of the vehicle 20 and where there is occurrence of traffic congestion.

Furthermore, in the case of creating a route from the departure point to the destination, the route determination unit 105 may create a route that does not pass through a via-point.

Furthermore, the route determination unit 105 may preferentially set, as the destination, a traffic light that is installed on a road in front of a station or on a road with a high volume of traffic.

Furthermore, the route determination unit 105 may set a railroad crossing as the destination. Then, in the case of determining that, as a result of the vehicle 20 being guided along the created route, the vehicle 20 will arrive at the railroad crossing at a time when a crossing gate at the railroad crossing will be closed, the route determination unit 105 may cause the route to be displayed on the display 11 to guide the vehicle 20 to the railroad crossing.

Furthermore, the information terminal 10A may acquire traffic regulation information or information about a parking lot which is full, and the route determination unit 105 may set a location where the traffic regulation is enforced or a location near the parking lot which is full as the destination. The vehicle 20 may then be guided to the destination.

Moreover, the information terminal 10 or 10A may include a module that is capable of receiving frequency modulation (FM) radio waves, and may acquire information about traffic congestion through FM radio waves.

Moreover, the embodiments described above each describe an example where a driver of the vehicle 20 drives by looking at the route displayed on the display 11 and guides the vehicle 20 to the destination, but the vehicle 20 may alternatively be an autonomous vehicle or an unmanned transport vehicle, and autonomous driving may be performed to the destination, along the route determined by the route determination unit 105.

Moreover, the vehicle 20 may include a speaker instead of the display 21 for advertisement. An audio advertisement may be output from the speaker while the vehicle 20 is stopped at a red light, or is caught in traffic congestion and is traveling at a low speed or is stopped.

Moreover, the embodiments described above are merely examples, and the present disclosure may be embodied by making modifications without departing from the spirit of the present disclosure as appropriate.

Moreover, configurations and processes described in the present disclosure may be freely combined to the extent that no technical conflicts exist.

Furthermore, a process that is described to be performed by one apparatus may be shared and performed by a plurality of apparatuses. Processes described to be performed by different apparatuses may be performed by one apparatus. In a computer system, which function is to be implemented by which hardware configuration (server configuration) may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (Floppy® disks, hard disk drives (HDDs), etc.) and optical disks (CD-ROMs, DVD discs, Blu-ray discs, etc.), read-only memories (ROMs), random access memories (RAMs), EPROMs, EEPROMs, magnetic cards, flash memories, optical cards, and any type of medium suitable for storing electronic instructions.

What is claimed is:

1. An information processing apparatus comprising a controller configured to:
acquire information about traffic;
specify, on a basis of the information about traffic that is acquired, a location where a vehicle that outputs an advertisement to outside is desired to travel at a speed at or below a predetermined speed or to stop;
determine a route from a location of the vehicle to the location that is specified; and
guide the vehicle to the location that is specified, on a basis of the route that is determined.

2. The information processing apparatus according to claim 1, wherein
the information about traffic includes information about a traffic signal, and
the location where the vehicle is desired to travel at a speed at or below the predetermined speed or to stop includes a location where a traffic signal is to turn red.

3. The information processing apparatus according to claim 1, wherein
the information about traffic includes information about traffic congestion, and
the location where the vehicle is desired to travel at a speed at or below the predetermined speed or to stop includes a location where there is occurrence of traffic congestion.

4. The information processing apparatus according to claim 1, wherein the route is determined in such a way as to pass through a predetermined via-point.

5. An information processing method comprising:
acquiring information about traffic;
specifying, on a basis of the information about traffic that is acquired, a location where a vehicle that outputs an advertisement to outside is desired to travel at a speed at or below a predetermined speed or to stop;
determining a route from a location of the vehicle to the location that is specified; and
guiding the vehicle to the location that is specified, on a basis of the route that is determined.

6. A non-transitory storage medium storing a program for causing a computer to:
acquire information about traffic;
specify, on a basis of the information about traffic that is acquired, a location where a vehicle that outputs an advertisement to outside is desired to travel at a speed at or below a predetermined speed or to stop;
determine a route from a location of the vehicle to the location that is specified; and
guide the vehicle to the location that is specified, on a basis of the route that is determined.
